(19) United States
(12) Patent Application Publication
(10) Pub. No.: US 2026/0330518 A1
(43) Pub. Date: Oct. 22, 2026

(54) PRODUCT ANOMALY DETECTOR

(71) Applicant: Synchrony Bank, Stamford, CT (US)

(72) Inventors: Kavya Devineni, Kansas City, MS (US); Vivek Ravi, Stamford, CT (US); Ved Lad, San Jose, CA (US)

(21) Appl. No.: 19/183,273

(22) Filed: Apr. 18, 2025

(51) Int. Cl. G06Q 30/0601

(52) U.S. Cl. CPC G06Q 30/0607

(57) ABSTRACT

Embodiments may include a computer-implemented method for classifying product offerings as being prohibited or allowed. Methods may include accessing a marketing file. The marketing file may be downloaded from a site. The marketing file may include information for a target offering from a merchant. Methods may include extracting the target offering from the marketing file to generate an extract of the marketing file. Methods may include processing the extract in a machine learning model to determine if the target offering is compatible with a strategic objective. The machine learning model may be configured to classify a compatibility of an offering with the strategic objective. Methods may also include outputting a classification of the compatibility of the target offering with the strategic objective.

### BACKGROUND

Financial payment processors and other financial institutions facilitate transactions between consumers and merchants. These entities ensure the secure transfer of funds through a complex network of technologies and processes, with product and service classification being an aspect of their operations.

Accurate classification is important for several reasons. It aids in risk management by assessing the risk associated with different types of transactions. For example, high-risk categories such as gambling or adult entertainment require more stringent monitoring and controls compared to low-risk categories like groceries or utilities. Compliance with regulatory requirements, including anti-money laundering (AML) and counter-terrorism financing (CTF) laws, is another factor. Proper classification may ensure that transactions are appropriately flagged and reported to regulatory bodies.

Additionally, classification may help in structuring fees correctly. Different products and services may attract different processing fees, and accurate classification allows payment processors to apply the correct fee structures, ensuring fair pricing for merchants and profitability for the processors. It also plays a role in fraud prevention by identifying unusual transaction patterns that may indicate fraudulent activities. For instance, a sudden spike in high-value electronics purchases could trigger fraud detection mechanisms.

Moreover, classification provides valuable data for analytics, helping financial institutions understand consumer behavior, market trends, and business performance. This data can be used to develop targeted marketing strategies and improve customer service.

However, product classification comes with its challenges. The diverse range of products and services available in the market makes classification a complex task, as each product category may have unique characteristics that need to be considered. The dynamic nature of the market, with new products and services emerging regularly. Ensuring accuracy and consistency in classification across different merchants and transaction types is also challenging, as inaccurate classification can lead to compliance issues, financial losses, and reputational damage.

Given these factors, financial payment processors and institutions have a significant interest in developing advanced systems and methods for product classification. Innovations in this area can enhance operational efficiency, improve risk management, and ensure regulatory compliance, ultimately contributing to a more secure and efficient financial ecosystem.

### BRIEF SUMMARY

Embodiments of the present invention classify product offerings through models that identify target offerings in marketing files. The marketing files can include both text and images. Models may determine if the target offering is compatible with a strategic objective. These models may include machine learning models, which may include large language models.

Embodiments may include a computer-implemented method for classifying product offerings as being prohibited or allowed. Methods may include accessing a marketing file. The marketing file may be downloaded from a site. The marketing file may include information for a target offering from a merchant. Methods may include extracting the target offering from the marketing file to generate an extract of the marketing file. Methods may include processing the extract in a machine learning model to determine if the target offering is compatible with a strategic objective. The machine learning model may be configured to classify a compatibility of an offering with the strategic objective. Methods may also include outputting a classification of the compatibility of the target offering with the strategic objective.

Systems and computer-readable medium for executing the method are also described.

### Terms

The term “offering” refers to a product or service made available by a merchant to customers or potential customers. This encompasses all tangible goods, digital products, or services that are designed, marketed, and distributed to fulfill customer needs or demands. The term includes, but is not limited to, items for sale, subscription-based services, rental goods, and any value-added service that is provided as part of a commercial transaction or business proposition.

“Strategic objective” can refer to a goal that guides the direction and priorities of an organization. It encompasses business objectives, such as revenue growth, market expansion, and customer satisfaction, and security objectives, such as safeguarding assets, ensuring data protection, and maintaining regulatory compliance. Strategic objectives may also include policies that prohibit certain types of goods or services from being offered, such as those related to sensitive or controversial areas (e.g., abortion services, firearms sales). Strategic objectives may also include policies that permit or encourage certain types of goods or services to be offered (e.g., education, child development). These objectives are designed to align an organization's resources and efforts to achieve long-term success while balancing the pursuit of business opportunities with the mitigation of risks and adherence to ethical or regulatory standards.

The terms “cutoff” and “threshold” refer to predetermined numbers used in an operation. For example, a cutoff score can refer to a score above which payment accounts with that minimum score are excluded from analysis. As another example, a threshold value may be a value above or below which a particular classification applies. Either of these terms can be used in either of these contexts. A cutoff or threshold may be “a reference value” or derived from a reference value that is representative of a particular classification or discriminates between two or more classifications. A cutoff may be predetermined with or without reference to the characteristics of the sample or the subject. A cutoff may be chosen after and based on output of the test data. A reference value can be selected as representative of one classification (e.g., a mean) or a value that is between two clusters of the metrics (e.g., chosen to obtain a desired sensitivity and specificity). As another example, a reference value can be determined based on statistical simulations of samples. Any of these terms can be used in any of these contexts. Such a reference value can be determined in various ways, as will be appreciated by the skilled person. For example, metrics can be determined for two different cohorts of subjects with different known classifications, a reference value can be selected as representative of one classification (e.g., a mean) or a value that is between two clusters of the metrics (e.g., chosen to obtain a desired sensitivity and specificity). As another example, a reference value can be determined based on statistical simulations of samples. A particular value for a cutoff, threshold, reference, etc. can be determined based on a desired accuracy (e.g., a sensitivity and specificity).

A “machine learning model” (ML model) can refer to a software module configured to be run on one or more processors to provide a classification or numerical value of a property of one or more samples. An ML model can be generated using sample data (e.g., training data) to make predictions on test data. One example is an unsupervised learning model. Another example type of model is supervised learning that can be used with embodiments of the present disclosure. Example supervised learning models may include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naïve Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model may include linear regression, logistic regression, deep recurrent neural network (e.g., long short-term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

The term “classification” as used herein refers to any number(s) or other characters(s) that are associated with a particular property of a sample. For example, a “+” symbol (or the word “positive”) could signify that an offering is classified as being compatible with a strategic objective. The classification can be binary (e.g., positive or negative) or have more levels of classification (e.g., a scale from 1 to 10 or 0 to 1), including probabilities.

The term “true positive” (TP) can refer to offerings having a classification compatible with a strategic objective. True positive generally refers to offerings having a compatible classification and are designated with the compatible classification.

The term “true negative” (TN) can refer to offerings having a classification indicating incompatibility with a strategic objective. True negative generally refers to offerings incompatible with a strategic objective and are designated with the incompatible classification.

The term “false positive” (FP) can refer to offerings classified as having a classification indicating compatibility but are actually incompatible with the strategic objective.

The term “false negative” (FN) can refer to subjects classified as having a classification indicating incompatibility but are actually compatible with the strategic objective.

The “positive” and “negative” terms may be reversed based on context. For example, a “positive” may be a classification indicating incompatibility with a security objective, while a “negative” may be a classification indicating compatibility with a security object. The “positive” and “negative” terms would be consistent throughout TP, TN, FP, and FN. The designation of what is “positive” and what is “negative” may be arbitrary and may not affect the effectiveness of the actual method.

The terms “sensitivity” or “true positive rate” (TPR) can refer to the number of true positives divided by the sum of the number of true positives and false negatives. Sensitivity may characterize the ability of a method to correctly identify a proportion of the population that truly has the classification. For example, sensitivity may characterize the ability of a method to correctly identify the number of offerings having the classification.

The terms “specificity” or “true negative rate” (TNR) can refer to the number of true negatives divided by the sum of the number of true negatives and false positives. Specificity may characterize the ability of a method to correctly identify a proportion of the population that truly does not have a classification. For example, specificity may characterize the ability of a method to correctly identify the number of offerings not having the classification.

The term “about” or “approximately” can mean within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, up to 10%, up to 5%, or up to 1% of a given value. Alternatively, particularly with respect to biological systems or processes, the term “about” or “approximately” can mean within an order of magnitude, within 5-fold, and more preferably within 2-fold, of a value. Where particular values are described in the application and claims, unless otherwise stated the term “about” meaning within an acceptable error range for the particular value should be assumed. The term “about” can have the meaning as commonly understood by one of ordinary skill in the art. The term “about” can refer to ±10%. The term “about” can refer to ±5%.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an architecture for classifying offerings of a merchant according to embodiments of the present invention.

FIG. 2 illustrates a webpage according to embodiments of the present invention.

FIG. 3 illustrates a social media post according to embodiments of the present invention.

FIG. 4 illustrates actions by entities for classifying a target offering according to embodiments of the present invention.

FIG. 5 illustrates an architecture for generating embeddings according to embodiments of the present invention.

FIG. 6 illustrates a work flow for generating scraping code according to embodiments of the present invention.

FIG. 7 illustrates a workflow for determining whether a webpage should be classified as having a prohibited offering according to embodiments of the present invention.

FIG. 8 illustrates a method of classifying a target offering according to embodiments of the present invention.

FIG. 9 illustrates stages of a large language model according to embodiments of the present invention.

FIG. 10 illustrates analyzing data with machine learning models according to embodiments of the present invention.

FIG. 11 illustrates a computing system according to embodiments of the present invention.

### DETAILED DESCRIPTION

Financial payment processors and other financial institutions often classify offerings in a transaction. They may have an interest in not facilitating transactions that are in certain categories, such as firearms, alcohol, tobacco, adult entertainment, pornography, gambling, regulated services [e.g., medical devices or treatments], among other categories. Although merchants or business partners may agree with a financial institution that such categories are prohibited, these merchants or business partners may sometimes, intentionally or unintentionally, provide the offering. For example, the merchant or business partner may forget about restrictions or may interpret the prohibitions as not including a particular offering. The financial institution therefore has an interest in monitoring and verifying offerings that are marketed or sold online.

Identifying offerings that are prohibited may not be best handled through a simple keyword search. For example, a financial institution may prohibit transactions involving alcohol. A merchant may sell a set of wine glasses. A keyword search for “wine” would incorrectly flag the wine glasses as prohibited for involving alcohol. There may also be some subjectivity in determining if a product is prohibited under a strategic objective. For example, the strategic objective may prohibit marijuana-related products. A merchant selling clothing with marijuana-themed messages or images may or may not be prohibited, depending on the financial institution's interpretation of the policy. Merchants may also promote offerings using images in addition to or in place of text. Classifying offerings may need to distinguish between a photo of a handgun being sold and a photo of artwork having a handgun.

Embodiments of the present invention improve on classification of offerings as compatible or incompatible with a strategic objective. Models may identify the target offering in a marketing file. The identification may be through a machine learning model. The marketing file may then be processed by a model to determine the compatibility of the offering with the strategic objective. The model may be a machine learning model, including a large language model. Marketing files may include both webpages that sell the particular offering as well as social media posts that promote the offering. Embodiments may use offline versions of marketing files to avoid using prohibited web crawlers.

The ability to identify whether a product falls under a certain class of prohibited products—such as firearms, alcohol, or adult entertainment—enhances the functionality and reliability of various technologies, particularly in fields such as financial technology, e-commerce platforms, and network security. This capability allows systems to enforce legal, regulatory, and ethical standards effectively, ensuring compliance and safeguarding users and organizations from liability.

In financial technology, for example, systems that can identify prohibited products in transactions or payment processes enable financial institutions to adhere to strict compliance requirements. This capability is essential for detecting and preventing illicit activities such as money laundering or unauthorized purchases of restricted items. Without precise identification mechanisms, financial systems risk processing prohibited transactions, which can lead to significant regulatory violations and reputational harm.

In e-commerce platforms, the ability to identify prohibited products ensures that platforms can maintain trust and integrity by preventing the sale of restricted items. By classifying products based on their compliance status, these systems can automatically block listings, flag potential violations, and streamline enforcement measures. This reduces manual review processes and enhances the platform's ability to operate within legal frameworks.

In network security, identifying prohibited products in data traffic or communications helps prevent the dissemination or advertisement of restricted content. Systems that can detect these categories enable organizations to filter out inappropriate material, protect end-users, and enforce workplace or community standards.

This technological capability significantly improves existing systems by introducing a layer of contextual awareness and regulatory compliance that was previously unattainable. It transforms static systems into dynamic ones capable of adapting to complex legal and ethical landscapes, ensuring that they operate responsibly, efficiently, and in alignment with societal standards.

The use of machine learning models to classify products as prohibited or non-prohibited significantly enhances computational efficiency by automating the identification process with high accuracy and speed. These models can analyze vast amounts of data in real-time, applying learned patterns to determine the classification of a product based on its attributes, descriptions, or metadata. By leveraging machine learning, the system reduces the need for manual review or rule-based logic, which can be cumbersome and error-prone when dealing with large and diverse datasets. This efficiency enables faster decision-making, reduces computational overhead, and ensures that resources are allocated effectively, allowing the technology to scale seamlessly with increasing data volumes and complexity.

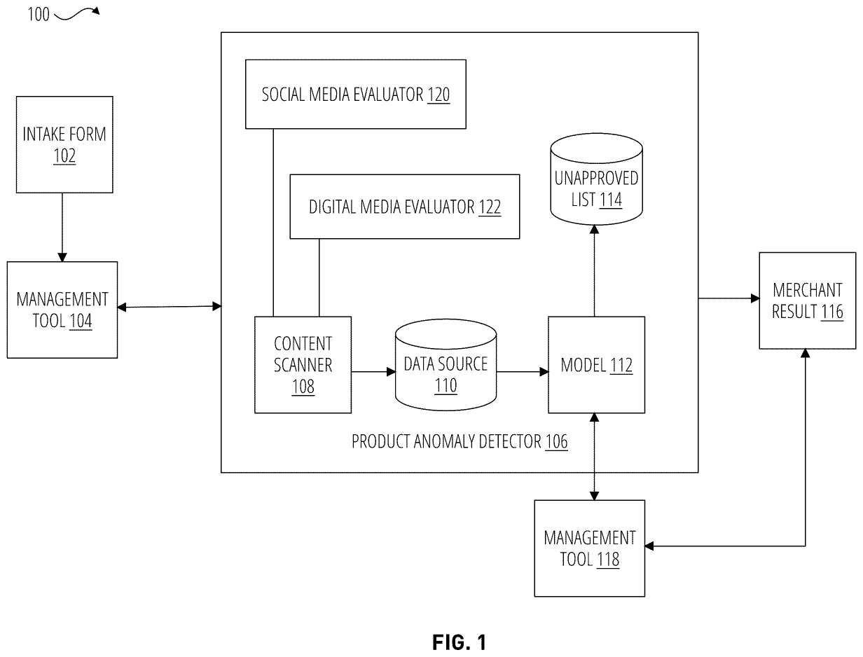

FIG. 1 shows an architecture 100 for classifying offerings of a merchant. An intake form 102 may be provided. A merchant may complete intake form 102, or intake form 102 may be stored in a database. Intake form 102 may provide information on the merchant and its offerings. Intake form 102 may also provide information regarding merchant contact information, merchant website location, merchant social media accounts, and/or merchant employees. In some embodiments, intake form 102 may indicate specific strategic objectives for additional scrutiny.

Intake form 102 may be provided to management tool 104. Management tool 104 may be a business process management (BPM) tool, such as Activiti. Management tool 104 may support standards such as the Business Process Modeling Notation (BPMN) to create graphical representations of processes, making them easier to understand and optimize. Management tool 104 may provide services, including audit, query, and notification capabilities, which can be extended and customized to meet specific business needs. Management tool 104 may also benefit from community support, which may aid documentation. Management tool 104 may be monitoring for intake form 102.

Management tool 104 may provide merchant information to Product Anomaly Detector 106. Product Anomaly Detector 106 may be triggered when management tool 104 receives intake form 102. Product Anomaly Detector 106 may include content scanner 108. Content scanner 108 may find information regarding offerings by merchants. In embodiments, content scanner 108 may instruct social media evaluator 120 to access social media accounts related to the merchant. For example, social media evaluator 120 may access accounts listed on intake form 102 for the merchant. In embodiments, accessing the social media accounts may include monitoring accounts and posts in real-time. In some embodiments, accessing the social media accounts may include accessing a data store with downloaded and/or offline content from social media accounts related to the merchant. Social media evaluator 120 may store the posts in a data source. Social media evaluator 120 may transmit social media posts to content scanner 108.

Content scanner 108 may also instruct digital media evaluator 122 to access downloaded and/or offline marketing files from the merchant. The marketing files may include files that are from the merchant website. The marketing files may provide an option for a potential customer to purchase the offering. In some embodiments, the marketing files may be advertisements for the offering. The advertisements may reside on a third party server. Digital media evaluator 122 may store the marketing files in a data source. Digital media evaluator 122 may transmit the marketing files to content scanner 108.

Content scanner 108 may identify the offering in files provided by social media evaluator 120 and/or digital media evaluator 122. Content scanner 108 may identify the offering through using a machine learning model, which may be a natural language processor. For example, the provided marketing file may be a webpage for selling a wine glass. The webpage may include an image of the wine glass and a product description, along with price and quantity options. Content scanner 108 may identify wine glass as being the offering of the webpage. In embodiments, content scanner 108 may extract text from the marketing file. The text may also include text describing an image in the marketing file. The text may include the offering, whether explicitly identified or not.

In some embodiments, content scanner 108 may identify an image representing the offering. For example, the marketing file may include an image of the product or service being promoted. As an example, the marketing file may include an image of a wine glass. Content scanner 108 may determine the image represents the offering. Content scanner 108 may use a machine learning model, including a large multimodal model (LMM), such as LLaVA or other LMMs, that is trained to understand and generate content on both images and text.

Content scanner 108 sends the portion of the marketing file representing the offering to data source 110. Data source 110 may be a database, data warehouse, data lake, data mart, or any other suitable source. The portion of the marketing file may be text and/or an image.

The portion of the marketing file may be sent from data source 110 to model 112. Model 112 may be a machine learning model, including any machine learning model described herein. Model 112 may be a large language model. Model 112 may be trained to classify whether a portion of a marketing file falls under an unapproved list 114.

The unapproved list 114 may be a list of categories that do not align with a strategic objective of a business partner working with the merchant. For example, the business partner may be a financial services company that provides private label credit cards for the merchant. The business partner may have an objective to avoid offerings considered vices or otherwise controversial. As examples, unapproved list 114 may include firearms, gambling, adult entertainment, marijuana, or tobacco. As other examples, unapproved list 114 may include products or services that may fall under licensing or certification requirements, for which the business partner does not want to verify. For example, unapproved list 114 may include medical devices, legal services, financial services, or prescription eyewear. In some embodiments, unapproved list 114 may include items that may or may not align with a political or other goal, such as environmental sustainability or diversity, equity, and inclusion (DEI) initiatives. Unapproved list 114 then may or may not include fossil fuel purchases.

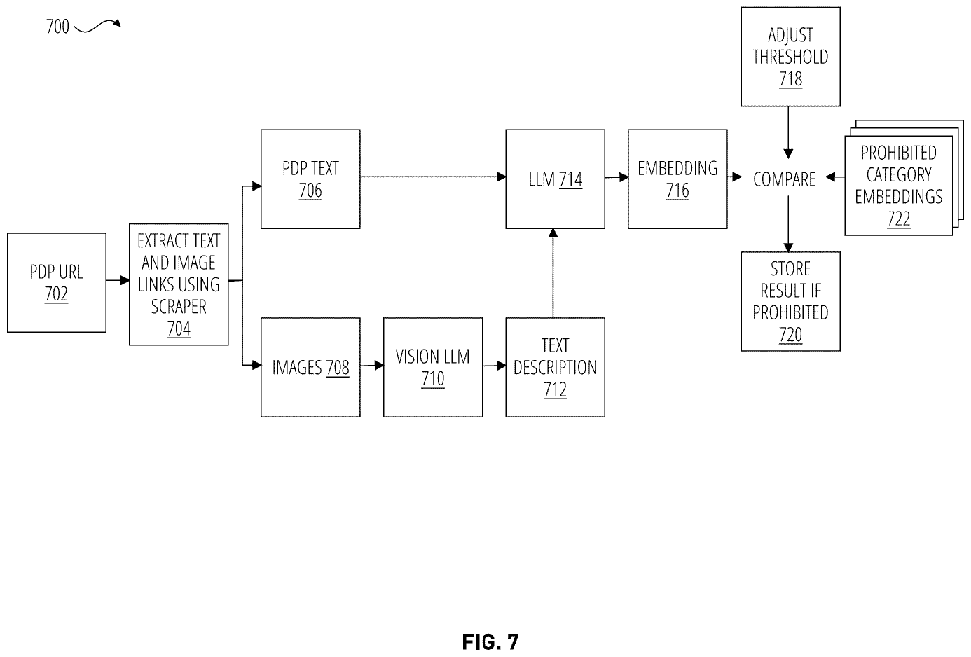

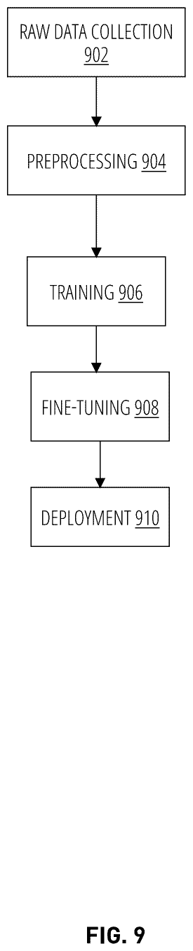

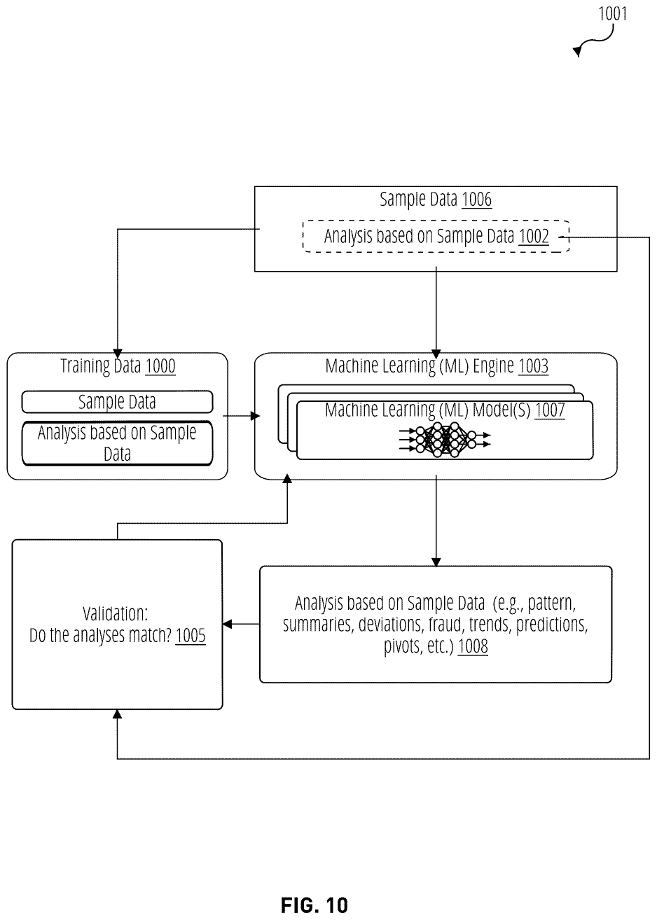

Model 112 may be trained to determine if the portion of the marketing file related to the offering is on the unapproved list 114. The determination can be performed by a machine learning model as described with FIG. 9 or FIG. 10. Briefly, model 112 may use natural language processing to determine if the offering aligns with the unapproved list 114, therefore being incompatible with a strategic objective. Model 112 may involve encoding the portion of the marketing file into an embedding space. The embedding space may be decoded to determine whether the offering aligns with the unapproved list 114. FIG. 7 describes the embedding comparison in more detail. Product Anomaly Detector 106 may be used for a plurality of offerings.

Model 112 may output the determination of whether an offering falls under the unapproved list 114. This determination is outputted as merchant result 116. Merchant result 116 may be provided to management tool 118, along with details of the run of model 112. Management tool 118 may communicate results (e.g., by an email) to an analyst, who can then determine how to handle an output showing an offering that falls under the unapproved list 114. The analyst may determine to affirm or overrule the merchant result 116. The analyst decision may be entered into management tool 118. Management tool 118 may then update model 112 so that model 112 can make more accurate determinations in the future.

If the analyst affirms that the offering is on the unapproved list 114, the analyst may choose to send a communication to the merchant describing the finding. The analyst may ask for the merchant to cease transactions with the offering. The analyst may update procedures at the business partner to cut off support for transactions with the offering. In some embodiments, the analyst may enact financial penalties related to the unapproved offering. In some embodiments, the analyst may determine that business partner can no longer work with the merchant and start procedures to end the relationship.

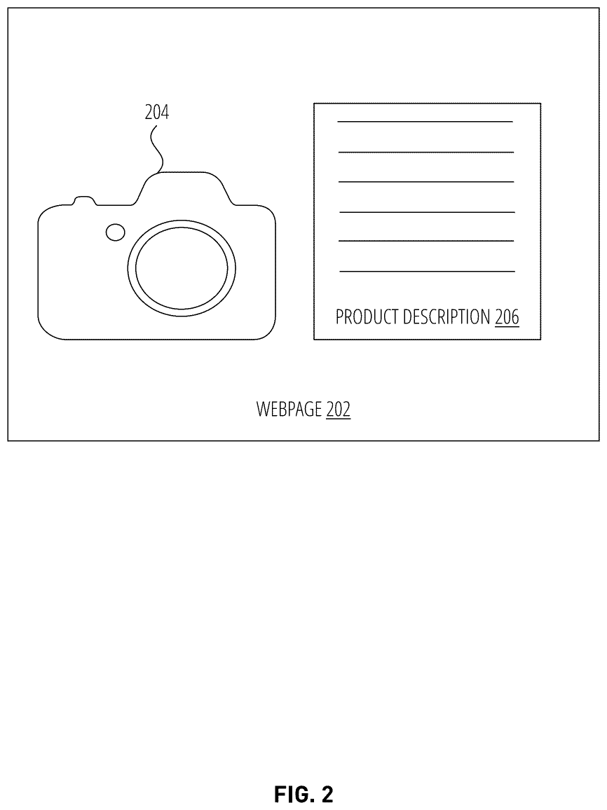

FIG. 2 shows a webpage 202. Webpage 202 may be on a merchant website. Webpage 202 may be a page presented to a user to initiate a transaction for the offering. In some embodiments, webpage 202 may include multiple different offerings, such as a catalog of offerings. Webpage 202 may include product image 204, which may be a photograph or rendering of the offering. Webpage 202 may include product description 206, which may be a text description of the product. Webpage 202 may be accessed by digital media evaluator 122. Webpage 202 may include markup language and other data that may not directly relate to the offering.

Webpage 202 may be a digital document designed to be displayed in a web browser, including various types of content and programming elements. Webpage 202 typically may include HTML (HyperText Markup Language), which provides the structural framework for organizing content such as text, images, and multimedia. To enhance interactivity and functionality, the webpage may incorporate JavaScript, a scripting language enabling dynamic behaviors such as form validation, interactive menus, or real-time updates. For stylistic and layout purposes, CSS (Cascading Style Sheets) may be used to define visual design attributes like colors, fonts, and positioning. Additionally, webpages may embed other formats, such as SVG (Scalable Vector Graphics) for vector images, JSON (JavaScript Object Notation) for data interchange, and media files like audio and video in formats such as MP3, MP4, or WebM. The combination of these technologies may allow webpages to deliver rich, interactive experiences to users while supporting a wide range of functionalities.

Webpage 202 can be downloaded and stored offline by capturing its constituent resources and saving them to a local storage medium for later access without an internet connection to the server hosting webpage 202. Downloading may involve retrieving the HTML file, along with associated assets such as images, scripts, stylesheets, and multimedia files. Tools such as web browsers or specialized software can perform this task by identifying and downloading all linked resources referenced in the HTML, including external files loaded via URLs. Once downloaded, the resources may be stored in a directory structure that replicates their online organization, enabling the webpage to function as intended offline. Additionally, metadata such as timestamps and file paths can be stored to maintain consistency and enable seamless access. Offline storage may also involve caching techniques or packaging the webpage and its dependencies into a self-contained format, such as a web archive file (e.g., MHTML or WARC), ensuring portability and usability across devices. In some embodiments, extracted details of webpage 202 may be stored rather than the entire webpage 202.

In contrast to downloading webpage 202, a web crawler is an automated program designed to systematically access and traverse webpages across the internet, primarily for indexing, data collection, or analysis. A crawler accesses webpages by sending HTTP requests, often targeting only specific components like the HTML structure, metadata, or hyperlinks, without necessarily downloading all associated assets. Unlike manual downloads, crawlers are optimized for scalability, speed, and breadth, frequently abiding by restrictions defined in the website's robots.txt file. Additionally, crawlers often navigate interconnected pages through links, gathering information across multiple pages, whereas downloading typically focuses on a single page or a limited set of pages. The intent behind a crawler's access is to analyze or catalog content, not necessarily to reproduce the user-facing experience. A web crawler may be excluded in systems and methods described herein.

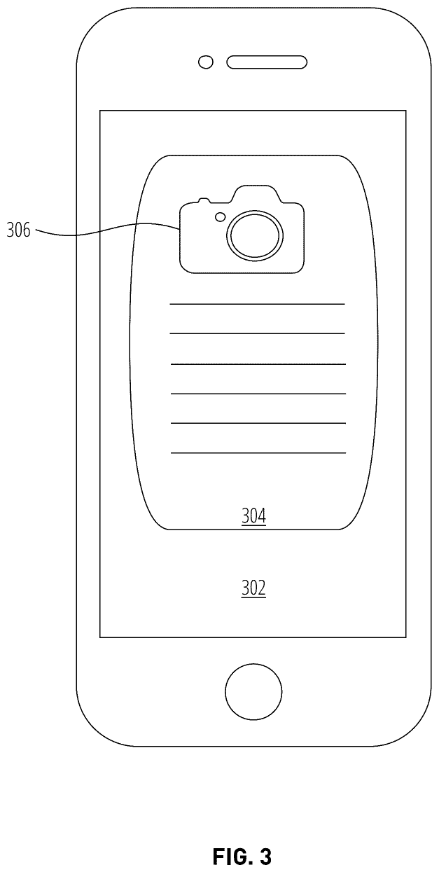

FIG. 3 shows a mobile phone 302 displaying a social media post 304. The social media post 304 may have a product 306 as the subject of the post. Examples of social media include platforms such as Facebook, Instagram, X (formerly known as Twitter), BlueSky, Threads, LinkedIn, TikTok, Snapchat, Pinterest, and Reddit. Social media platforms may store and display content by leveraging distributed databases and content delivery networks (CDNs) to ensure scalability, reliability, and rapid access. User-generated content, such as text posts, images, videos, and metadata (e.g., timestamps, geolocation, user tags, user comments), may be stored in databases optimized for structured and unstructured data. These platforms may use relational databases for user profiles and relationships, while object storage systems or NoSQL databases handle large multimedia files. To display content, platforms may dynamically generate user interfaces tailored to the viewer's device, preferences, and interaction history. They employ algorithms to personalize the content feed, ensuring relevant and engaging material appears first. Cached versions of frequently accessed content are distributed via CDNs to reduce latency and bandwidth usage, enabling seamless and efficient user experiences across diverse devices and network conditions.

The social media post 304 may be downloaded using a web browser or a mobile application. The social media post 304 may then be accessed offline in embodiments. In some embodiments, social media post 304 may be access in real-time as the merchant is posting the content. The social media post 304 may be associated with a social media account. Social media post 304 may include product 306 in text. In some embodiments, social media post 304 may include product 306 in images or video.

In some embodiments, social media post 304 may be displayed for a predetermined amount of time or a predetermined number of views (e.g., Snapchat, Instagram stories). Such posts may be captured in real-time when accessed or captured through an application, such as a screen capture or video capture program.

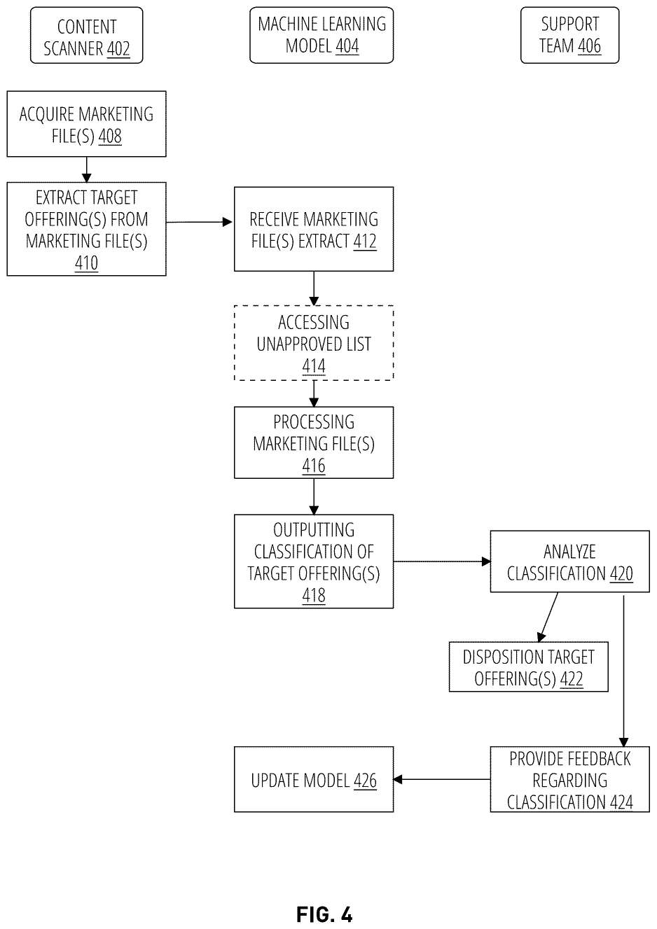

FIG. 4 shows actions by various entities for classifying a target offering. Content scanner 402 may be content scanner 108 or code used to scrape marketing files (e.g., code generated by agentic workflow 600). Machine learning model 404 may be model 112, machine learning (ML) engine 1003, machine learning (ML) model(s) 1007, or any machine learning model described herein. Support team 406 may include human analysts. These analysts may be part of a quality review team or a product review team. Support team 406 may be responsible for determining how a financial institution, card issuer, or other entity handles an unapproved product. Support team 406 may be a single individual or a group of individuals.

At block 408, content scanner 402 acquires the marketing file(s). The marketing file(s) may be stored in a data source (e.g., database, data mart, data lake). The marketing file(s) may be acquired through visiting websites or social media feeds and saving the content to the data source. The marketing file may be text, images, or a combination thereof.

At block 410, content scanner 402 extracts target offering(s) from the marketing file(s). The target offering may be the subject of the marketing file. Extraction may be as described with block 704 of inference workflow 700. In some embodiments, the target offering may extract elements of the marketing file. For example, the marketing file may include a title that specifically lists the offering. As another example, the marketing file may include tags, comments, or metadata identifying the offering. In some embodiments, the target offering may be identified by using a machine learning model, including a large language model. A machine learning model may be trained from a dataset of training marketing files with labels indicating the target offering associated with the training marketing file. In some embodiments, a large language model may identify the target offering by interpreting language in the marketing file. In embodiments, the machine learning model used in block 410 may be a separate model from machine learning model 404. In embodiments, the machine learning model used in block 410 may be part of machine learning model 404.

At block 412, machine learning model 404 receives the marketing file(s) extract with the target offering(s) from content scanner 402. The content scanner 402 may save the marketing file(s) extract in a data source (e.g., data source 110). The content scanner 402 may annotate the files or create another file with the target offerings. In some embodiments, machine learning model 404 may be notified that marketing file extracts are ready for processing. In embodiments, machine learning model 404 may have a schedule to process marketing files.

At block 414, machine learning model 404 may access an unapproved list. Block 414 may be an optional action. The unapproved list may be unapproved list 114 or a list of prohibited categories described herein. Machine learning model 404 may train for identifying offerings from the unapproved list and may not need to access the unapproved list. For example, machine learning model 404 may be trained using a dataset of training marketing files and a label of whether the file includes an unapproved (or approved) offering. The dataset may include separate subsets for each category in the unapproved list (e.g., drugs, firearms, alcohol). In embodiments, machine learning model 404 may generate embeddings from the marketing file extract, as described with embedding 716 of inference workflow 700. In some embodiments, machine learning model 404 may access an approved list instead of an unapproved list.

In block 416, machine learning model 404 may process the marketing file. In embodiments, machine learning model 404 may be a large language model (LLM), described in more detail in FIG. 9. The LLM may use a transformer. The transformer model may encode the marketing file or portions thereof into an embedding space. The embedding of the marketing file may be compared to embeddings of training marketing files known to be unapproved or approved. Marketing files that may have an unapproved offering may be clustered in a space separate from those files with approved offerings. The embedding of the marketing file(s) from block 412 may be decoded to provide a measure of how likely or unlikely the marketing file(s) is to have an unapproved or approved offering.

At block 418, machine learning model 404 may output a classification of the target offering(s) in the marketing file. The classification may be determined using a probability or likelihood generated by machine learning model 404. If the probability or likelihood is over a certain threshold for a classification, then the target offering may be considered to be in that classification. In embodiments, the classification may be determined from comparing an embedding from the marketing file extract to an embedding for an entry of the unapproved list. The output may be an electronic communication (e.g., email, text message, push notification) to support team 406. In some embodiments, the output may be displayed on a monitor.

At block 420, the support team 406 may analyze the classification. For example, the classification may be that the target offering is unapproved. The classification may include the category that the offering falls under (e.g., alcohol). Support team 406 may review the determination by machine learning model 404 that the target offering is unapproved for pertaining to alcohol. In some embodiments, machine learning model 404 may also provide the probability or confidence of a classification. Machine learning model 404 may also provide/reference the marketing file or the marketing file extract. Support team 406 may review any information from machine learning model 404 and determine whether the machine learning model 404 is correct in its classification.

At block 422, support team 406 may disposition the target offering(s). Dispositioning the target offering may involve sending a communication to the merchant or partner. The communication may instruct the merchant to stop offering the target offering. In some embodiments, dispositioning the target offering may involve support team 406 cutting off the payments for the target offering or the merchant/partner. In some embodiments, support team 406 may enact financial penalties for the merchant/partner to pay. In some embodiments, support team 406 may determine that the relationship between a financial institution and the merchant/partner should end and may start procedures to end the relationship, particularly if the merchant/partner has had repeated instances (e.g., 2, 3, 4, 5 to 10, 10 to 20, or more than 20) of unapproved target offerings. Support team 406 may not take the specific action but instead recommend the action to another team that carries out the action.

At block 424, support team 406 may provide feedback regarding the classification. The feedback may be binary. For example, the feedback may be that the classification of the offering was accurate or inaccurate. If the feedback is that the classification was inaccurate, support team 406 may provide an explanation of why the classification was inaccurate or provide an example of a similar offering in the same classification. Support team 406 may be able to find the similar offering from the same merchant or partner. In some embodiments, the feedback may be that a category (e.g., sex, firearms, alcohol) of the offering was accurate or inaccurate. If the category was inaccurate, the feedback may include the correct category.

At block 426, machine learning model 404 may update the model based on the feedback. The model may retrain or fine-tune (e.g., block 906 or block 908 in FIG. 9) using the feedback.

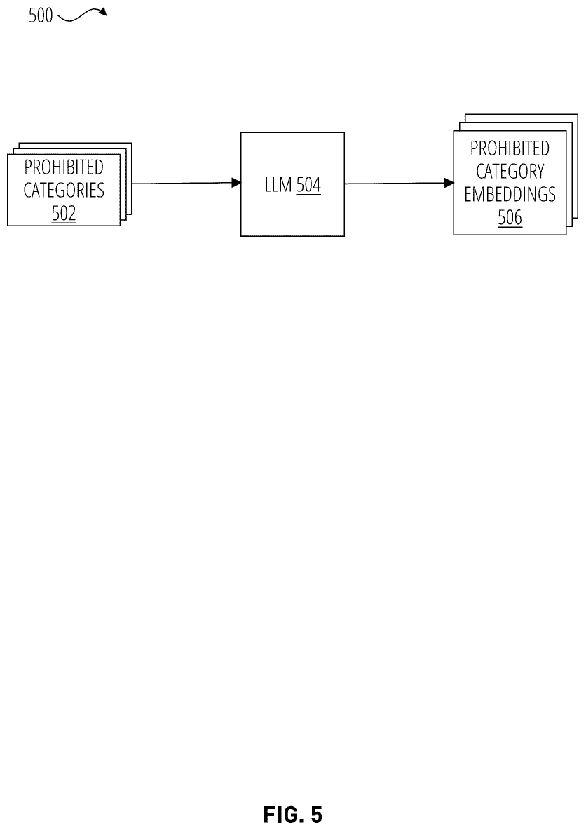

FIG. 5 presents a simplified illustration of an architecture 500 for generating embeddings for prohibited categories. A list of prohibited categories 502 is provided. The prohibited categories 502 may be provided from a financial payment processor or other financial institution. The list may include firearms, alcohol, tobacco, adult entertainment, pornography, gambling, regulated services [e.g., medical devices or treatments], or any other category described herein.

LLM 504 may be a pre-trained large language model (LLM), which may be any described herein. LLM 504 may convert each category descriptor into a vector (embedding). The categories may also be expanded with synonyms or related key terms (e.g., “guns” or “weapons” for firearms; “beer” or “wine” for alcohol). The expanded categories may be processed by LLM 504 to create embeddings for the expanded category. LLM 504 may be a local LLM or a cloud-based LLM. Pre-trained text-embedding models may include transformers, BERT from Google, RoBERTa from Meta, OpenAI's GPT Embeddings, Sentence-BERT for similarity tasks, Microsoft's MPNet and DeBERTa, non-contextual models like GloVe, Word2Vec, and FastText, Google's Universal Sentence Encoder, Allen AI's ELMo, Meta's multilingual LASER embeddings, Microsoft's E5 for retrieval tasks, BAAI's BGE models, or any model based on those models.

The output of LLM 504 is prohibited category embeddings 506, which may include a set of vectors. Each prohibited category may have one vector. The prohibited category embeddings 506 may be stored in a database.

New embeddings can be generated when new prohibited categories are introduced. New embeddings may also be generated when existing prohibited categories are refined or updated.

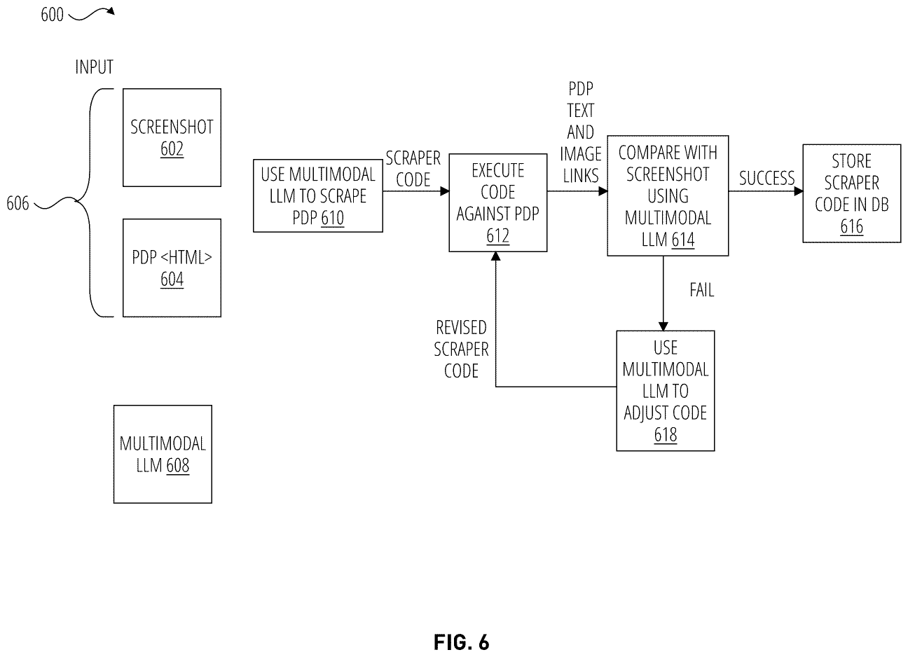

FIG. 6 shows an agentic workflow 600 for automatically generating and executing scraping code to retrieve product details page (PDP) text and product images from a given uniform resource locator (URL) or website using a multimodal LLM. The PDP may be a webpage for a target offering or may be a social media post promoting the target offering.

Input 606 may include a screenshot 602 and the HTML file for the PDP 604. A headless browser (e.g., a web browser without a graphical user interface [GUI]) may be triggered to navigate to the given URL. A screenshot 602 of the loaded page is captured. Screenshot 602 may be saved in a temporary data store.

Input 606 is fed into multimodal LLM 608. Multimodal LLM 608 may be an LLM that can interpret visual data. LLMs may include OpenAI's GPT-4 Vision, Anthropic's Claude 3 models, Google's Gemini series, open-source options like LLaVA and CogVLM, OpenAI's foundational CLIP model, DeepMind's Flamingo, Alibaba's Qwen-VL, Salesforce's BLIP and BLIP-2, the mPLUG series of foundation models, or any model based on these models.

At block 610, the LLM may be prompted to generate code to scrape all textual product details and product image links from the webpage. The LLM generates scraper code, which may be in a designated scraping language (e.g., Python+BeautifulSup, or Node.js+Cheerio).

At block 612, the scraper code is executed against the PDP. The executed code extracts product text (e.g., titles, descriptions, specifications, bullet points) and/or product image URLs. The extracted text and image URLs may be stored in a structured format (e.g., JSON).

At block 614, multimodal LLM 608 compares the scraped results with the content in the screenshot 602. The multimodal LLM 608 may determine if the extracted text and image links likely match the content in screenshot 602. A prompt to multimodal LLM 608 may ask if the extracted results accurately capture the primary text and product images of the screenshot 602. The multimodal LLM 608 may determine a score indicating a level of similarity between the extracted results and the primary text and product images of screenshot 602. If the score is above a threshold, then multimodal LLM 608 may determine that the extracted results match the content in screenshot 602.

At block 616, if the multimodal LLM 608 determines a successful match, the scraper code is stored in a repository. The scraper code may be keyed by domain or a merchant identifier. Future scrapes can then reuse the scraper code.

If the multimodal LLM 608 determines the extracted results do not match the content of the screenshot 602, then multimodal LLM 608 is prompted to refine or correct the scraper code. The revised code may then be executed against the PDP at block 612. The process of comparison and adjusting code is iterated until accurate results are achieved or a maximum number of retries is reached. If the maximum number of retries is reached, then multimodal LLM 608 may be adjusted (e.g., hyperparameters varied manually or automatically) or another LLM may be used.

Scraper code stored in a database may result in extracted PDP text and product image links that accurately represent a PDP. In some embodiments, agentic workflow 600 may be bounded to prevent malicious code generation or infinite loops. For example, multimodal LLM 608 may be given prompts that limit the multimodal LLM 608 to certain packages and/or restricting its ability to write destructive code. As an example, timeouts, retry limits, and error logging may be implemented.

FIG. 7 shows inference workflow 700 for determining whether a PDP aligns with any prohibited category embeddings. Inference workflow 700 may be executed by an LLM or any suitable computing system. Inference workflow 700 starts with PDP URL 702, where the URL of the PDP is provided. The PDP URL 702 may be received from a merchant system or other external system.

At block 704, the text and image links are extracted using a scraper. The scraper code may be generated by agentic workflow 600. The scraper code may separate out PDP text 706 and images 708.

PDP text 706 may be processed by LLM 714 to create an embedding. The LLM 714 may be the same model used for generating the embedding of prohibited categories.

Images 708 may be sent to a vision LLM 710. Vision LLM 710 may be prompted to describe the image in natural language. The vision LLM 710 may be any LLM capable of interpreting visual data, including those described with multimodal LLM 608. The result of vision LLM 710 may be text description 712. Text description 712 may be processed by LLM 714 to generate embedding 716.

Embedding 716 generated from the PDP text 706 and images 708 may be compared with prohibited category embeddings 722. Prohibited category embeddings 722 may be prohibited category embeddings 506. The comparison may be performed using cosine similarity or other similarity metrics. If the comparison determines that a similarity score is over a threshold, then the product of the PDP URL 702 may be labeled as prohibited or potentially prohibited. If both text and images are in the PDP, inference workflow 700 may involve requiring multiple (e.g., 2, 3, 4, or more) embeddings to have similarity scores over the threshold to label a PDP URL 702 as prohibited. The threshold may be adjusted (block 718) depending on desired sensitivity or specificity for labeling as being part of prohibited categories or allowed categories.

At block 720, if the comparison results in labeling the PDP URL 702 as prohibited, the result is stored. The URL, screenshot, scraping results, and/or prohibited category may be saved in a data store for manual review and/or automated blocking.

If the comparison does not result in labeling the PDP URL 702 as prohibited, the PDP URL 702 may be labeled as allowed. The URL, screenshot, scraping results, and/or the closest prohibited category may be saved in a data store for manual review and/or automated blocking.

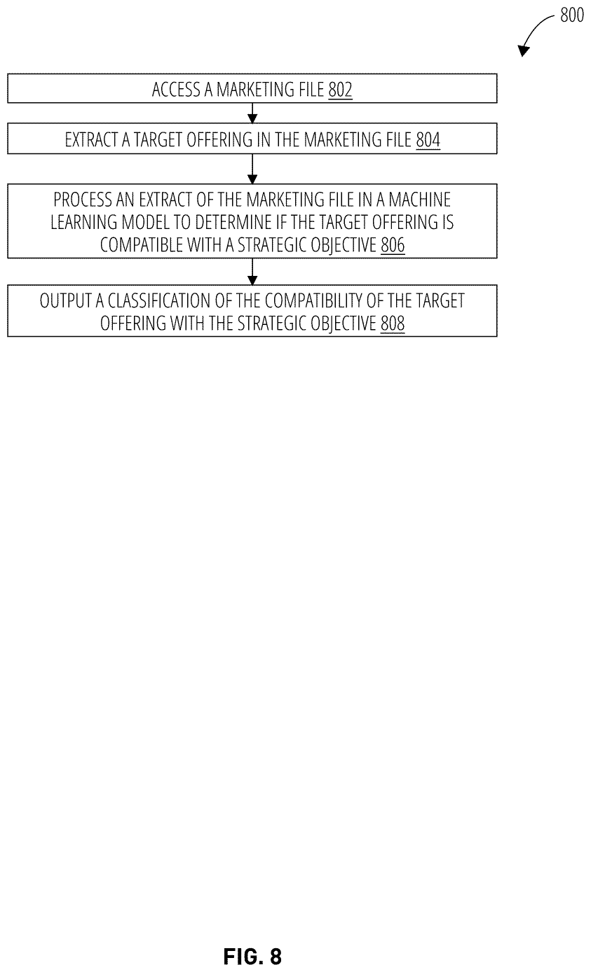

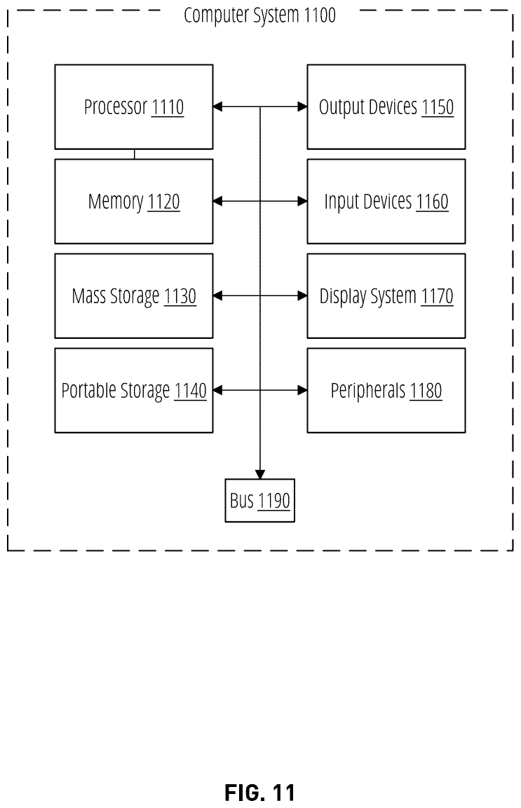

FIG. 8 shows a method 800 of classifying a target offering. Method 800 may include components and actions from FIG. 4, FIG. 5, FIG. 6, or FIG. 7, and may involve any computing device or machine learning model described herein, including those in FIG. 10 and FIG. 11.

In block 802, method 800 accesses a marketing file. The marketing file may be downloaded from a site. The marketing file may be accessible from a data source that is not available to the public. Method 800 may exclude using a web crawler. As an example, accessing the marketing file may be as described with agentic workflow 600 obtaining input 606, screenshot 602, and PDP <html> 604. The marketing file may include information for a target offering from a merchant. The marketing file may be a webpage from a website of the merchant. In some embodiments, the marketing file may be a page for selling the offering. For example, the marketing file may include an option to add to a virtual shopping cart or to checkout. The marketing file may include a social media post by the merchant. The marketing file may include a text description of the offering. The marketing file may include an image of the offering. The image may be the offering by itself or the offering with other subjects (e.g., people, background, landscape). In some embodiments, the image may not include the offering. The offering may be a product or a service.

In block 804, method 800 extracts the target offering from the marketing file to generate an extract of the marketing file. The target may be extracted as in block 410. In some embodiments, the extract may or may not be the entirety of the text of the marketing file. One or more extracts may be generated. For example, a first extract may be generated from text, and a second extract may be generated from an image/video of the marketing file. In some embodiments, the target offering may be identified through analyzing keywords of the file, including the title, metadata (e.g., comments, keywords), headings, text, and/or images. In some embodiments, an offering identification machine learning model may be used to determine the target offering. As an example, the offering identification machine learning model may be a large language model (e.g., as described with FIG. 9). For example, a large language model (LLM) may be trained and fine-tuned to understand the relationships within text or other parts of the marketing file. The LLM may output the target offering based on language in the marketing file. In some embodiments, the offering identification machine learning model may be trained using a dataset of training marketing files with labels indicating the target offering. Parameters of the offering identification machine learning model may be optimized so that the machine learning model outputs the target offering when a marketing file is input into the model. Extracting the target offering may be performed by scraping the marketing file, as described with inference workflow 700 (e.g., extracting text and image links [block 704]),

[symbol]

In block 806, method 800 processes an extract of the marketing file in a strategic objective machine learning model to determine if the target offering is compatible with a strategic objective. The extract may include the target offering. The strategic objective machine learning model be separate from or may include the target offering machine learning model. The strategic objective may be a prohibition on an offering category. The strategic objective machine learning model may be configured to classify a compatibility of an offering with the strategic objective. The strategic objective machine learning model may be trained using a data set including a plurality of training offerings and corresponding labels indicating the compatibility of the offering with the strategic objective. In some embodiments, the training data set may include labels indicating categories of the strategic objective (e.g., firearms, gambling, adult entertainment, sex, marijuana, tobacco, or others mentioned with unapproved list 114). The strategic objective machine learning model may be a large language model. Processing the marketing file may be similar to block 416.

Processing the marketing file may include generating an embedding. The embedding may include separate embeddings for text and images of the marketing file. For example, the embedding may be generated as described with embedding 716. The embedding may be transformed into a measure of compatibility of the target offering with the strategic objective. In some embodiments, the embedding may be transformed into a measure of compatibility with a particular category of the strategic objective. The embedding space may show clusters corresponding to the different categories of strategic objective. The comparison may be as described with inference workflow 700.

In block 808, method 800 outputs a classification of the compatibility of the target offering with the strategic objective. Method 800 may include outputting a classification of the compatibility of a plurality of target offerings with the strategic objective. Outputting the classification may be similar to block 418. The classification may be a binary classification (e.g., approved or unapproved). The classification may be determined with the model calculating a confidence score for compatibility or incompatibility and then comparing the score with a threshold value. The threshold value may be determined to achieve a certain level of sensitivity, specificity, true positives, true negatives, false positives, or false negatives. In some embodiments, the output may be the confidence score, which an analyst may further analyze. In some embodiments, the output may be the category of the strategic objective. The category may be determined with the model calculating a confidence score for the target offering belonging in each category. The category with the highest confidence score over a threshold value may determine the outputted category. The target offering may be dispositioned as described with block 422.

Method 800 may further include receiving feedback regarding the determination of the compatibility of the target with the strategic objective. The feedback may indicate a misclassification of the target offering by the machine learning model. The feedback may indicate a miscategorization of a strategic objective for the target offering. In some embodiments, feedback may indicate a correct classification of the target offering and/or a correct categorization of a strategic objective. The feedback may indicate other similar offerings as the target offering. The feedback may be provided as described with block 424. The machine learning model may be updated with feedback to improve an accuracy of the machine learning model in classifying the compatibility of offerings with the strategic objective. The machine learning model may be retrained or fine-tuned with the feedback. The model may be updated as described with block 426.

The updated machine learning model may block or facilitate the blocking of a future transaction with a future target offering. The updated machine learning model may classify future target offering as compatible or incompatible with the strategic objective.

Embodiments of the present technology improve financial technology, security technology, computer technology, e-commerce technology, and other technologies. Embodiments of the present technology improve accuracy of classifying target offerings.

The output of the classification may result in updating a user interface. The user interface may list merchants, target offerings, and whether the merchant or target offering is allowed or prohibited. The user interface may allow a user to execute a verification of a prohibited target offering. For example, the user interface may display the marketing file, the extract, and/or the prohibited category. In embodiments, the user interface may provide an option for the user to perform blocking or queue the target offering for blocking by another team.

FIG. 9 shows a block diagram of stages in a large language model (LLM), which may be any LLM described herein.

At block 902, raw data may be collected. Raw data can be obtained from marketing files as described herein. At block 904, the data may be preprocessed. Preprocessing may include cleaning data (e.g., handling missing values, removing duplicates, correcting inaccuracies, removing outliers), normalizing data, encoding categorical data, transforming data, and/or reducing dimensionality.

The machine-learning model can be a natural-language processing model trained using the previous input data and corresponding data-collection script generated based on the previous input data. Examples of the machine-learning model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, meta-learning, reinforcement learning, deep learning, and other such algorithms and/or methods.

In some instances, the machine-learning model is a transformer model (e.g., a large-language model (LLM)) obtained from a models database. In some instances, the machine-learning model is trained using self-supervised learning based on a large corpus of text data, such that the machine-learning model can generate the data-collection script. In addition to training the model, various prompts can be used for prompt engineering of the machine-learning model for generating the data-collection script. Examples of the content machine-learning model can include, but are not limited to, BERT model, Claude LLM, Falcon 40B, Ernie, GPT-3, GPT-3.5, GPT 4, Lamda, and Llama.

In some instances, the machine-learning model can access one or more supplemental resources from a retrieval-augmentation generation (RAG) system to generate a data-collection script. For example, the one or more supplemental resources include social media, news sources, and/or business databases. By leveraging the supplemental sources, the machine-learning model can generate additional offering information.

### Model Selection

In some instances, the machine-learning model can be generated based on different types of machine-learning architectures. An example architecture used for transformer models can include a transformer model that includes an encoder and a decoder. Another example can include a Bidirectional Encoder Representations from Transformers (BERT), which is configured to understand the context of a word in search queries by considering the words on both its left and right.

In yet another example, a machine-learning architecture can include a Generative Pre-trained Transformer (GPT) that is trained using autoregressive language modeling and masked self-attention techniques. For example, the masked self-attention techniques can include masking future tokens when generating a contextual representation representing a given token, such that the contextual representation is determined only based on past tokens. The autoregressive language modeling techniques can then predict the next token of an output sequence based on the contextual representations of the text tokens.

Other examples of machine-learning architectures can include: (1) a Text-to-Text Transfer Transformer (T5) that converts all natural-language processing tasks into a text-to-text format, unifying various tasks under a single model architecture; and (2) a Vision Transformer (ViT) that extends the transformer architecture to process longer text sequences and image data, respectively, thereby facilitating the corresponding model to be used across different domains.

### Training Phase

At block 906, the model is trained. An illustrative example process of training the transformer model (e.g., a GPT model) is as follows. For the training dataset (e.g., the previous input data and corresponding data-collection script), the masked self-attention process can begin by transforming each word in a given training text sequence into three vectors: the query (Q), key (K), and value (V) vectors. A Q vector can represent what information the token is querying about other tokens, a K vector can represent the token's context used to establish relationships with other tokens, and a V vector can represent the token's actual content/information. In some instances, the Q, K, and V vectors can be obtained by multiplying the input embeddings by learned weight matrices.

An attention score for a particular word can be calculated by taking the dot product of the Q vector of the word with the K vectors of all words in the sequence, thereby producing a score that reflects the relevance of each word pair. The attention scores can be used as weights, which can be applied to the Q, K, V vectors to generate a weighted contextual representation of the particular word. Stated differently, the attention score can be used as a weight to transform the Q, K, V vectors of a given word to generate a weighted, computed representation that can be used to train the corresponding transformer model.

In some instances, a mask can be applied to the self-attention mechanism such that a contextual representation of a given token is determined without weights associated with future tokens. As a result, an attention score of a particular token can be adjusted to disregard information from tokens that have not been processed yet. The attention scores can then be scaled by the square root of the key dimension to stabilize training and passed through a softmax function to convert the attention scores into probabilities, ensuring they sum to one. The transformation can identify the most relevant words while downplaying less important ones. The resulting attention weights can then be used to compute a weighted sum of the V vectors, thus producing a new contextual representation for each token that incorporates contextual information from the entire sequence.

To enhance the model's ability to capture various types of relationships, self-attention mechanisms can use multiple sets of Q, K, and V matrices, also referred to as multi-head attention. Each set, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

The transformer model can then be trained using autoregressive language modeling to predict a subsequent token of a target sequence based on the contextual representations that represent the preceding tokens. For each position in the sequence, the transformer model accesses a contextual representation of the token, which was generated using masked self-attention mechanism. The transformer model can then output a probability distribution over a vocabulary for the subsequent token, conditioned on the sequence of preceding tokens. The subsequent token can then be compared with a corresponding token of the training data to calculate a loss. The loss measures the discrepancy between the predicted token and the actual token, providing a signal for the model to adjust its parameters. The loss can then be used to adjust parameters of the transformer model, including the parameters of the Q, K, V matrices.

Through iterative training iterations, the transformer model learns to minimize this loss across the entire training dataset. This process ensures that the model generates coherent and contextually appropriate sequences by leveraging the learned representations and adjusting its parameters based on the training data.

### Fine-Tuning Phase Using Prompts

At block 908, the model is fine tuned. In some instances, model 112 can construct one or more prompts that can be submitted with the input data (e.g., marketing file) to enhance and increase the accuracy of the classification of an offering. As used herein, the term “prompt” can refer to as an input sequence generated to direct a corresponding machine-learning model's generation process towards producing a target output. In some instances, a filtering prompt includes a sequence of text tokens in a specific format (e.g., text, XML data, JSON data) and language (e.g., English, Spanish).

In some instances, the prompts are machine-generated prompts that are generated by one or more computer systems without user intervention. For example, the one or more filtering prompts can be constructed using prompt engineering. Prompt engineering can include techniques for designing and implementing prompts within a machine-learning system to generate target responses or actions. In some instances, prompt engineering leverages a combination of linguistic approaches, machine-learning algorithms, and domain knowledge to formulate prompts that elicit specific outputs from a corresponding machine-learning model. The prompt engineering process typically begins with an analysis of a target or a problem domain, followed by the formulation of prompts tailored to achieve the desired results.

As an illustrative example for optimizing prompts, a prompt P can be defined as a sequence of tokens, tailored to elicit specific responses from a machine-learning model. The model employs an objective function O(P, R) to evaluate the quality of generated responses R given the prompt P. The responses R can be generated based on a machine-learning language model LM processing the prompt P (e.g., the function LM(P)). Different types of objective functions can be selected depending on the task and targeted output. For example, an objective function can correspond to a text summarization technique using ROUGE scores. In another example, the objective function can correspond to a translation quality assessment technique using BLEU scores. In some instances, optimization techniques like gradient descent or evolutionary algorithms are used iteratively refine the prompt P to maximize O(P, R), to facilitate the model to consistently produce accurate, relevant, and contextually appropriate outputs (e.g., the data-collection script 218). For example, the optimal prompt P* can be determine based on maximizing the objective function O:

P*=argmax O(P, LM(P)) Equation (1)

Through the iterative refinement process, prompt engineering enhances the corresponding model's performance across various natural language processing tasks.

In some instances, prompt engineering includes a selection of input formats and structures. The input-format selection can include determining the syntactic and semantic characteristics of the prompts that will effectively guide the machine-learning model towards the desired outputs. In some instances, linguistics and computational linguistics can be used to select input formats that are semantically meaningful and contextually relevant. The input-format selection can ensure that the prompts effectively communicate the desired tasks or questions to the machine-learning model. The prompt engineering process can also include an optimization of prompt parameters. The optimization can include fine-tuning various parameters such as prompt length, complexity, and specificity to enhance the machine-learning model's performance on targeted tasks. Different prompt formulations and configurations such as grid search or Bayesian optimization can be implemented to optimize the prompt parameters. Additionally or alternatively, techniques such as zero-shot learning or few-shot learning can be implemented to fine-tune the machine-learning models to generalize from limited prompt examples.

The prompt engineering process can be configured based on an underlying machine-learning model architecture and training data. For example, an appropriate pre-trained machine-learning model architecture (e.g., GPT, BERT, or Transformer) that aligns with the task requirements and available computational resources can be identified for a given task. In some instances, the machine-learning model can be fine-tuned on task-specific data to further improve probability of outputting target responses. Various types of training datasets can be used to train and fine-tune the machine-learning model, so as to enable the machine-learning model to understand and generate responses to prompts accurately.

In some instances, an iterative process of designing, testing, and optimizing prompts is implemented based on feedback from initial model outputs. This iterative approach allows for continuous improvement and refinement of the prompt engineering process, ultimately leading to better-performing machine-learning models. Additionally or alternatively, ongoing monitoring and evaluation of model performance can be used to identify any errors or biases introduced by the prompts and prompt engineering process, in which the feedback data can be generated based on the evaluation. The feedback data can be used to further adjust the parameters of the machine-learning models, such that the machine-learning models can be updated to improve accuracy in generating the target responses.

### Deployment Phase

At block 910, the model may be deployed. The trained and fine-tuned machine-learning model can be applied to input data classify the offering. To begin the deployment process, model 112 can tokenize the merged data input a sequence of text tokens. For example, the merged data can be tokenized to provide the following sequence: [“The”, “product”, “is”, “a”, “beverage”, . . . ]. In some instances, the machine-learning model uses Byte Pair Encoding (BPE) techniques to further split a single token (e.g., “in”, “sufficient”).

Model 112 can assign each token with a particular index value in the vocabulary (e.g., “beverage”=E[5]). Then, model 112 can convert each token into a vector representation (e.g., an embedding) based on a pre-trained embedding matrix. For example, for a vocabulary size V and embedding dimension dᵢ, the embedding matrix E is of size V×d, in which the vector eᵢ can be generated for the text token tᵢ based on using the index value a looking of a corresponding row of embedding matrix E.

E:eᵢ=E[tᵢ] Equation (2)

Model 112 can then process the sequence of embeddings (e₁, e₂, e₃, . . . eₙ) that represent the sequence of tokens by adding positional encodings to account for the order of tokens. In some instances, positional encodings are vectors added to each token embedding to inject information about the position of tokens in the sequence. A matrix X can be formed that includes the sequence of position-encoded vectors.

For the matrix X, model 112 can then determine a contextual representation for each position-encoded vector of the matrix X. In particular, for each position-encoded vector, model 112 can generate a set of Q, K, V vectors for the position-encoded vector. As described herein, a Q vector can represent what information the token is querying about other tokens, a K vector can represent the token's context used to establish relationships with other tokens, and a V vector can represent the token's actual content/information.

In some instances, to enhance the model's ability to capture various types of relationships, the position-encoded vector can be represented by multiple sets of Q, K, and V matrices (i.e., multi-head attention). Each set of Q, K, V vectors, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

An attention score can be calculated for the set of Q, K, V vectors as follows:

Attention (Q, K, V)=softmax((QK^{T})/\sqrt{(dₖ)})V Equation (3)

The (QK^{T})/\sqrt{dₖ} can be used to compute the raw attention scores, in which dₖ is the dimensionality of the key vectors. Then, the softmax function is applied to the raw attention score to normalize it into a probability distribution. Model 112 can apply the attention score to a V vector of the corresponding set of Q, K, V vectors, such that the weighted Q, K, V vectors can be used as the contextual representation of the position-encoded vector of matrix X. In the instances in which multi-head attention is used, the multiple sets of weighted Q, K, V vectors can be concatenated and linearly transformed using a weight matrix W^{O} to generate the contextual representation of the position-encoded vector. The above process can be iterated through other position-encoded vectors of matrix X to generate a set of contextual representations associated with the merged data.

Machine-learning model 112 can be applied to the set of contextual representations to generate the offering classification. In particular, the machine-learning model can process the set of contextual representations to predict each token of the output, in which the outputted tokens can correspond to an offering classification.

### Output Characteristics

As described herein, output of model 112 may be a classification of a target offering. The classification may be whether the target offering is compatible with a strategic objective. In some embodiments, the classification may be a degree of compatibility rather than a binary classification. The classification may be any classification described herein. The output may include an email message, a text message, or other communication.

FIG. 10 is a block diagram illustrating using one or more machine learning models 1007 of a machine learning engine 1003 to analyze data to recognize a pattern. The ML engine 1003 generates, trains, and uses the ML model(s) 1007 based using training data 1000. The ML engine 1003 trains the ML model(s) 1007 to generate an analysis 1008 on input of sample data 1006 into the ML model(s) 1007. The sample data 1006 may include data that is extracted from the data stores (e.g., a system that performs the method 800, a data store accessible by a server/app, a data store accessible by a user device). In some examples, the sample data 1006 may include data that is normalized, merged, and/or processed following extraction (e.g., by any of the systems listed above). In some examples, the sample data 1006 may include allocation option results, participant history, and/or modifications (e.g., by any of the systems listed above). In some examples, the sample data 1006 may include some preliminary validation data and/or analysis data, such as summary data (e.g., by any of the systems listed above).

The analysis 1008 output by the ML model(s) 1007 can include at least one pattern identified as part of the analysis 1008 of the sample data 1006. The pattern can include any type of patterns, for instance including patterns associated with high or low success ratios by participants, types of transactions or merchants favored for methods described herein, and/or types of users frequently requesting allocation options. In some examples, the analysis 1008 output by the ML model(s) 1007 can include various other elements of analyses described with method 800.

The training data that the ML engine 1003 uses to train the ML model(s) 1007 includes sample data (e.g., akin to the sample data 1006) as well as pre-generated assessment(s) corresponding to the sample data (e.g., akin to the analysis 1008 corresponding to the sample data 1006). Over the course of the initial training with training data 1000, the ML model(s) 1007 develop hidden layers between input layers and output layers, and/or weights and/or connections between nodes of the various layers, that each relate to various aspects of the analysis 1008, such as any of the aspects described herein (e.g., related to various types of patterns that can be detected and characteristics of those types of patterns).

Once the one or more ML models 1007 identify the analysis 1008, the analysis 1008 (and/or the indication of eligibility of the user account for the modification) can be output to a user (e.g., using a speaker or headphones) and/or to a recipient device that can process and/or put into effect the modification to the client account, for instance by opening a new line or modifying an existing line.

In some examples, the ML engine 1003 can continue to train and/or update the ML model(s) 1007 over time, for instance based on validation 1005 using the analysis 1008 and the sample data 1006. In some examples, an analysis 1002 of the sample data 1006 (separate from the analysis 1008 generated by the ML model(s) 1007) may be provided to the ML engine 1003 use in performing the validation 1005. In some examples, the analysis 1002 may be generated by a different entity than the ML model(s) 1007, for instance a different set of ML model(s) (not pictured) or one or more trusted human analysts. If, during validation 1005, the ML engine 1003 determines that the analysis 1008 generated by the ML model(s) 1007 matches the analysis 1002, the ML engine 1003 can treat this as positive feedback, and can perform further training of the ML model(s) 1007 based on the analysis 1008, the sample data 1006, and/or the analysis 1002, for instance to strengthen and/or reinforce weights associated with generating the analysis 1008 in the ML model(s) 1007, and/or to weaken or remove other weights other than those associated with generating the analysis 1008, in the ML model(s) 1007. If, during validation 1005, the ML engine 1003 determines that the analysis 1008 generated by the ML model(s) 1007 differs from the analysis 1002, the ML engine 1003 can treat this as negative feedback, and can perform further training of the ML model(s) 1007 based on the analysis 1008, the sample data 1006, and/or the analysis 1002, for instance to weaken and/or remove weights associated with generating the analysis 1008 in the ML model(s) 1007, and/or to strengthen and/or reinforce other weights other than those associated with generating the analysis 1008 in the ML model(s) 1007.

In some examples, the ML engine 1003 receives feedback during validation 1005 about the analysis 1008. The feedback can include a reaction by a user of a user device via a user interface, a reaction by a user determined based on sensor data from a user device, and/or decisions by a user and/or user device as whether or not to use the analysis 1008 for a further application. Positive feedback can be used to strengthen and/or reinforce weights associated with generating the analysis 1008 in the ML model(s) 1007, and/or to weaken or remove other weights other than those associated with generating the analysis 1008 in the ML model(s) 1007. Negative feedback can be used to weaken and/or remove weights associated with generating the analysis 1008 in the ML model(s) 1007, and/or to strengthen and/or reinforce other weights other than those associated with generating the analysis 1008 in the ML model(s) 1007.

The ML engine 1003 and/or the ML model(s) 1007 can include one or more neural network (NNs), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. Within FIG. 10, a graphic representing the trained ML model(s) 1007 is illustrated as a set of circles connected to another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. The ML engine 1003 and/or the ML model(s) 1007 can be part of any AI and/or ML modules, processes, or analysis operations discussed herein.

FIG. 11 illustrates an exemplary computing system 1100 that may be used to implement some aspects of the technology. For example, any of the computing devices, computing systems, network devices, network systems, servers, and/or arrangements of circuitry described herein may include at least one computing system 1100, or may include at least one component of the computer system 1100 identified in FIG. 11. The computing system 1100 of FIG. 11 includes one or more processors 1110 and memory 1120. Each of the processor(s) 1110 may refer to one or more processors, controllers, microcontrollers, central processing units (CPUs), graphics processing units (GPUs), arithmetic logic units (ALUs), accelerated processing units (APUs), digital signal processors (DSPs), application specific integrated circuits (ASICs), field-programmable gate arrays (FPGAs), or combinations thereof. Each of the processor(s) 1110 may include one or more cores, either integrated onto a single chip or spread across multiple chips connected or coupled together. Memory 1120 stores, in part, instructions and data for execution by processor 1110. Memory 1120 can store the executable code when in operation. The computing system 1100 of FIG. 11 further includes a mass storage device 1130, portable storage device(s) 1140 (e.g., drive(s) and/or other storage media), output devices 1150, user input devices 1160, a display system 1170 (e.g., graphics display), and peripheral device(s) 1180.

The components shown in FIG. 11 are depicted as being connected via a single bus 1190. However, the components may be connected through one or more data transport means. For example, processor 1110 and memory 1120 may be connected via a local microprocessor bus, and the mass storage device 1130, peripheral device(s) 1180, portable storage device 1140, and display system 1170 may be connected via one or more input/output (I/O) buses.

Mass storage device 1130, which may be implemented with a magnetic disk drive or an optical disk drive, is a non-volatile storage device for storing data and instructions for use by processor 1110. Mass storage device 1130 can store the system software for implementing some aspects of the subject technology for purposes of loading that software into memory 1120.

Portable storage device 1140 operates in conjunction with a portable non-volatile storage medium, such as a floppy disk, compact disk or digital video disc, to input and output data and code to and from the computer system 1100 of FIG. 11. The system software for implementing aspects of the subject technology may be stored on such a portable medium and input to the computer system 1100 via the portable storage device 1140.

The memory 1120, mass storage device 1130, or portable storage device 1140 may in some cases store sensitive information, such as transaction information, health information, or cryptographic keys, and may in some cases encrypt or decrypt such information with the aid of the processor 1110. The memory 1120, mass storage device 1130, or portable storage device 1140 may in some cases store, at least in part, instructions, executable code, or other data for execution or processing by the processor 1110.

Output devices 1150 may include, for example, communication circuitry for outputting data through wired or wireless means, display circuitry for displaying data via a display screen, audio circuitry for outputting audio via headphones or a speaker, printer circuitry for printing data via a printer, or some combination thereof. The display screen may be any type of display discussed with respect to the display system 1170. The printer may be inkjet, laserjet, thermal, or some combination thereof. In some cases, the output device 1150 (and/or associated circuitry) may allow for transmission of data over an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Output devices 1150 may include any ports, plugs, antennae, wired or wireless transmitters, wired or wireless transceivers, or any other components necessary for or usable to implement the communication types listed above, such as cellular Subscriber Identity Module (SIM) cards.

Input devices 1160 may include circuitry providing a portion of a user interface. Input devices 1160 may include an alpha-numeric keypad, such as a keyboard, for inputting alpha-numeric and other information, or a pointing device, such as a mouse, a trackball, stylus, or cursor direction keys. Input devices 1160 may include touch-sensitive surfaces as well, either integrated with a display as in a touchscreen, or separate from a display as in a trackpad. Touch-sensitive surfaces may in some cases detect localized variable pressure or force detection. In some cases, the input device circuitry may allow for receipt of data over an audio jack, a microphone jack, a universal serial bus (USB) port/plug, an Apple® Lightning® port/plug, an Ethernet port/plug, a fiber optic port/plug, a proprietary wired port/plug, a wired local area network (LAN) port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, personal area network (PAN) signal transfer, wide area network (WAN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Input devices 1160 may include any ports, plugs, antennae, wired or wireless receivers, wired or wireless transceivers, or any other components necessary for or usable to implement the communication types listed above, such as cellular SIM cards.

Input devices 1160 may include receivers or transceivers used for positioning of the computing system 1100 as well. These may include any of the wired or wireless signal receivers or transceivers. For example, a location of the computing system 1100 can be determined based on signal strength of signals as received at the computing system 1100 from three cellular network towers, a process known as cellular triangulation. Fewer than three cellular network towers can also be used—even one can be used—though the location determined from such data will be less precise (e.g., somewhere within a particular circle for one tower, somewhere along a line or within a relatively small area for two towers) than via triangulation. More than three cellular network towers can also be used, further enhancing the location's accuracy. Similar positioning operations can be performed using proximity beacons, which might use short-range wireless signals such as BLUETOOTH® wireless signals, BLUETOOTH® low energy (BLE) wireless signals, IBEACON® wireless signals, personal area network (PAN) signals, microwave signals, radio wave signals, or other signals discussed above. Similar positioning operations can be performed using wired local area networks (LAN) or wireless local area networks (WLAN) where locations are known of one or more network devices in communication with the computing system 1100 such as a router, modem, switch, hub, bridge, gateway, or repeater. These may also include Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. Input devices 1160 may include receivers or transceivers corresponding to one or more of these GNSS systems.

Display system 1170 may include a liquid crystal display (LCD), a plasma display, an organic light-emitting diode (OLED) display, a low-temperature poly-silicon (LTPO) display, an electronic ink or “e-paper” display, a projector-based display, a holographic display, or another suitable display device. Display system 1170 receives textual and graphical information, and processes the information for output to the display device. The display system 1170 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripheral device(s) 1180 may include any type of computer support device to add additional functionality to the computer system. For example, peripheral device(s) 1180 may include one or more additional output devices of any of the types discussed with respect to output device 1150, one or more additional input devices of any of the types discussed with respect to input device 1160, one or more additional display systems of any of the types discussed with respect to display system 1170, one or more memories or mass storage devices or portable storage devices of any of the types discussed with respect to memory 1120 or mass storage device 1130 or portable storage device 1140, a modem, a router, an antenna, a wired or wireless transceiver, a printer, a bar code scanner, a quick-response (“QR”) code scanner, a magnetic stripe card reader, a integrated circuit chip (ICC) card reader such as a smartcard reader or a EUROPAY®-MASTERCARD®-VISA® (EMV) chip card reader, a near field communication (NFC) reader, a document/image scanner, a visible light camera, a thermal/infrared camera, an ultraviolet-sensitive camera, a night vision camera, a light sensor, a phototransistor, a photoresistor, a thermometer, a thermistor, a battery, a power source, a proximity sensor, a laser rangefinder, a sonar transceiver, a radar transceiver, a lidar transceiver, a network device, a motor, an actuator, a pump, a conveyer belt, a robotic arm, a rotor, a drill, a chemical assay device, or some combination thereof.

The components contained in the computer system 1100 of FIG. 11 can include those typically found in computer systems that may be suitable for use with some aspects of the subject technology and represent a broad category of such computer components that are well known in the art. That said, the computer system 1100 of FIG. 11 can be customized and specialized for the purposes discussed herein and to carry out the various operations discussed herein, with specialized hardware components, specialized arrangements of hardware components, and/or specialized software. Thus, the computer system 1100 of FIG. 11 can be a personal computer, a hand held computing device, a telephone (“smartphone” or otherwise), a mobile computing device, a workstation, a server (on a server rack or otherwise), a minicomputer, a mainframe computer, a tablet computing device, a wearable device (such as a watch, a ring, a pair of glasses, or another type of jewelry or clothing or accessory), a video game console (portable or otherwise), an e-book reader, a media player device (portable or otherwise), a vehicle-based computer, another type of computing device, or some combination thereof. The computer system 1100 may in some cases be a virtual computer system executed by another computer system. The computer can also include different bus configurations, networked platforms, multi-processor platforms, etc. Various operating systems can be used including Unix®, Linux®, FreeBSD®, FreeNAS®, pfSense®, Windows®, Apple® Macintosh OS® (“MacOS®”), Palm OS®, Google® Android®, Google® Chrome OS®, Chromium® OS®, OPENSTEP®, XNU®, Darwin®, Apple® iOS®, Apple® tvOS®, Apple® watchOS®, Apple® audioOS®, Amazon® Fire OS®, Amazon® Kindle OS®, variants of any of these, other suitable operating systems, or combinations thereof. The computer system 1100 may also use a Basic Input/Output System (BIOS) or Unified Extensible Firmware Interface (UEFI) as a layer upon which the operating system(s) are run.

In some cases, the computer system 1100 may be part of a multi-computer system that uses multiple computer systems 1100, each for one or more specific tasks or purposes. For example, the multi-computer system may include multiple computer systems 1100 communicatively coupled together via at least one of a personal area network (PAN), a local area network (LAN), a wireless local area network (WLAN), a municipal area network (MAN), a wide area network (WAN), or some combination thereof. The multi-computer system may further include multiple computer systems 1100 from different networks communicatively coupled together via the internet (also known as a “distributed” system).

Some aspects of the subject technology may be implemented in an application that may be operable using a variety of devices. Non-transitory computer-readable storage media refer to any medium or media that participate in providing instructions to a central processing unit (CPU) for execution and that may be used in the memory 1120, the mass storage device 1130, the portable storage device 1140, or some combination thereof. Such media can take many forms, including, but not limited to, non-volatile and volatile media such as optical or magnetic disks and dynamic memory, respectively. Some forms of non-transitory computer-readable media include, for example, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L7), resistive random-access memory (RRAM/ReRAM), phase change memory (PCM), spin transfer torque RAM (STT-RAM), another memory chip or cartridge, or a combination thereof.

Various forms of transmission media may be involved in carrying one or more sequences of one or more instructions to a processor 1110 for execution. A bus 1190 carries the data to system RAM or another memory 1120, from which a processor 1110 retrieves and executes the instructions. The instructions received by system RAM or another memory 1120 can optionally be stored on a fixed disk (mass storage device 1130/portable storage device 1140) either before or after execution by processor 1110. Various forms of storage may likewise be implemented as well as the necessary network interfaces and network topologies to implement the same.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order that is logically possible. Additionally, portions of these steps may be used with portions of other steps from other methods. Also, all or portions of a step may be optional. Additionally, any of the steps of any of the methods can be performed with modules, units, circuits, or other means of a system for performing these steps.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

The above description of example embodiments of the present disclosure has been presented for the purposes of illustration and description and are set forth so as to provide those of ordinary skill in the art with a complete disclosure and description of how to make and use embodiments of the present disclosure. It is not intended to be exhaustive or to limit the disclosure to the precise form described nor are they intended to represent that the experiments are all or the only experiments performed. Although the disclosure has been described in some detail by way of illustration and example for purposes of clarity of understanding, it is readily apparent to those of ordinary skill in the art in light of the teachings of this disclosure that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the disclosure being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

The claims may be drafted to exclude any element which may be optional. As such, this statement is intended to serve as antecedent basis for use of such exclusive terminology as “solely”, “only”, and the like in connection with the recitation of claim elements, or the use of a “negative” limitation.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within embodiments of the present disclosure. The upper and lower limits of these smaller ranges may independently be included or excluded in the range, and each range where either, neither, or both limits are included in the smaller ranges is also encompassed within the present disclosure, subject to any specifically excluded limit in the stated range. Where the stated range includes one or both of the limits, ranges excluding either or both of those included limits are also included in the present disclosure.

All patents, patent applications, publications, and descriptions mentioned herein are hereby incorporated by reference in their entirety for all purposes as if each individual publication or patent were specifically and individually indicated to be incorporated by reference and are incorporated herein by reference to disclose and describe the methods and/or materials in connection with which the publications are cited. None is admitted to be prior art.

What is claimed is:

1. A computer-implemented method comprising:
accessing a marketing file, wherein the marketing file is downloaded from a site, and wherein the marketing file includes information for a target offering from a merchant;
extracting the target offering from the marketing file to generate an extract of the marketing file;
processing the extract in a machine learning model to determine if the target offering is compatible with a strategic objective, the machine learning model configured to classify a compatibility of an offering with the strategic objective; and
outputting a classification of the compatibility of the target offering with the strategic objective.

2. The computer-implemented method of claim 1, further comprising:
receiving feedback regarding the classification of the compatibility of the target offering with the strategic objective, and
updating the machine learning model with the feedback to improve an accuracy of the machine learning model in classifying the compatibility of offerings with the strategic objective.

3. The computer-implemented method of claim 1, wherein:
the machine learning model is a large language model.

4. The computer-implemented method of claim 1, wherein:
processing the extract in the machine learning model includes generating an embedding and transforming the embedding into a measure of compatibility of the target offering with the strategic objective.

5. The computer-implemented method of claim 1, wherein:
the machine learning model is trained using a dataset including a plurality of training offerings and corresponding labels indicating the compatibility of the offering with the strategic objective.

6. The computer-implemented method of claim 1, wherein:
the marketing file is a webpage from a website of the merchant.

7. The computer-implemented method of claim 1, wherein:
the marketing file includes a social media post by the merchant.

8. The computer-implemented method of claim 1, wherein:
the marketing file includes a text description of the offering.

9. The computer-implemented method of claim 1, wherein:
the marketing file includes an image of the offering.

10. The computer-implemented method of claim 1, wherein:
the strategic objective is a prohibition on an offering category.

11. The computer-implemented method of claim 1, wherein the offering is a product.

12. The computer-implemented method of claim 1, further comprising:
outputting the classification of the compatibility of a plurality of target offerings with the strategic objective.

13. A system comprising:
one or more processors; and
a non-transitory computer readable medium storing a plurality of instructions that, as a result of being executed by the one or more processors, causes the system to perform a method including:
accessing a marketing file, wherein the marketing file is downloaded from a site, and wherein the marketing file includes information for a target offering from a merchant;
extracting the target offering from the marketing file to generate an extract of the marketing file;
processing the extract in a machine learning model to determine if the target offering is compatible with a strategic objective, the machine learning model configured to classify a compatibility of an offering with the strategic objective; and
outputting a classification of the compatibility of the target offering with the strategic objective.

14. The system of claim 13, wherein the method further includes:
receiving feedback regarding the classification of the compatibility of the target offering with the strategic objective, and
updating the machine learning model with the feedback to improve an accuracy of the machine learning model in classifying the compatibility of offerings with the strategic objective.

15. The system of claim 13, wherein the method further includes:
processing the extract includes generating an embedding and transforming the embedding into a measure of compatibility of the target offering with the strategic objective.

16. The system of claim 13, wherein the method further includes:
outputting the classification of the compatibility of a plurality of target offerings with the strategic objective.

17. A non-transitory, computer-readable medium storing a plurality of instructions that, as a result of being executed by one or more processors of a computer system, cause the computer system to perform a method comprising:
accessing a marketing file, wherein the marketing file is downloaded from a site, and wherein the marketing file includes information for a target offering from a merchant;
extracting the target offering from the marketing file to generate an extract of the marketing file;
processing the extract in a machine learning model to determine if the target offering is compatible with a strategic objective, the machine learning model configured to classify a compatibility of an offering with the strategic objective; and
outputting a classification of the compatibility of the target offering with the strategic objective.

18. The non-transitory, computer-readable medium of claim 17, wherein the method further includes:
receiving feedback regarding the classification of the compatibility of the target offering with the strategic objective, and
updating the machine learning model with the feedback to improve an accuracy of the machine learning model in classifying the compatibility of offerings with the strategic objective.

19. The non-transitory, computer-readable medium of claim 17, wherein the method further includes:
processing the extract in the machine learning model includes generating an embedding and transforming the embedding into a measure of compatibility of the target offering with the strategic objective.

20. The non-transitory, computer-readable medium of claim 17, wherein the method further includes:
outputting the classification of the compatibility of a plurality of target offerings with the strategic objective.
